(19) United States
(12) Patent Application Publication
(10) Pub. No.: US 2009/0164413 A1
(43) Pub. Date: Jun. 25, 2009

(54) GENERIC TABLE STRUCTURE TO XML STRUCTURE MAPPING

(75) Inventors: Ebru Polat, Cagnes Sur Mer (FR); Lutz Rosenpflanzer, Valbonne (FR)

Correspondence Address: SCHWEGMAN, LUNDBERG & WOESSNER/SAP, P.O. BOX 2938, MINNEAPOLIS, MN, 55402, US

(73) Assignee: SAP AG, Walldorf (DE)

(21) Appl. No.: 11/963,208

(22) Filed: Dec. 21, 2007

(51) Int. Cl. G06F 17/30

(52) U.S. Cl. 707/2; 707/E17.045

(57) ABSTRACT

A method of mapping data to a tag based mark up language such as XML includes receiving a table of data from a source service in a format specific to the source service. A table header is read from the received table of data that includes a data schema specific to a destination service in the received table. A converter maps data in the table to one or more tag based mark up language tables compatible with the table header data schema of the destination service. The data schema may be varied to identify different data schemas for different destination services without modifying the converter.

### BACKGROUND

Service specific table data has been mapped to XML formats using predetermined mappings between table like structures and desired XML formats. However, a separate or different mapping may need to be created and maintained for different services or mapping of different tables.

### BRIEF DESCRIPTION OF THE DRAWINGS

FIG. 1 is a high level flow chart describing mapping of tables to a tag based language according to an example embodiment.

FIG. 2 is a screen shot of a table to be mapped according to an example embodiment.

FIG. 3 is a mapping of the table of FIG. 2.

FIG. 4 is an example user interface for identifying tables to be mapped and specifying output according to an example embodiment.

FIG. 5 is a further example of a table to be mapped according to an example embodiment.

FIG. 6 is an example mapping of a first row of data from the table in FIG. 5.

FIG. 7 is an example mapping of a second row of data from the table in FIG. 5.

FIG. 8 is a block diagram of an example computer system for executing methods according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of storage devices. The term “computer readable media” is also used to represent any means by which the computer readable instructions may be received by the computer, such as by different forms of wired or wireless transmissions. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

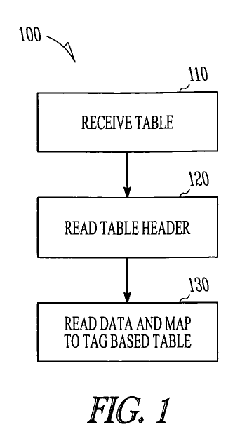

In various embodiments, a generic mapping for tables to tag based script language format, like XML format is provided. In one embodiment as illustrated in a flowchart in FIG. 1, a method 100 includes receiving a table of data from a source in a format specific to the source at 110. A table header is read from the received table of data at 120. The table header includes a data schema specific to a destination service in the received table. Data in the table is mapped at 130 using a converter to one or more tag based mark up language tables compatible with the table header data schema of the destination service. The data schema may be varied to identify different data schemas for different destination services without modifying the converter.

In one embodiment, the destination services comprise business objects having different data schema and the table of data comprises comma separated values. The table of data format corresponds to a relational database. The table of data from the source service corresponds to legacy application data and the destination service corresponds to a new application to which a user is upgrading. In one embodiment, the table header data and table data encapsulate data that corresponds to a destination service structure and service interface name.

In a further embodiment, a table to xml mapping routine handles intuitive mapping of a table derived from service structure into XML. The input tables contain the header and body data that correspond to a service structure, as well as the service interface name. The output XML is hence generated automatically according to the structure encapsulated in the header and body tables. The routine may be generic and business object independent. The header describes the mapping to the service structure.

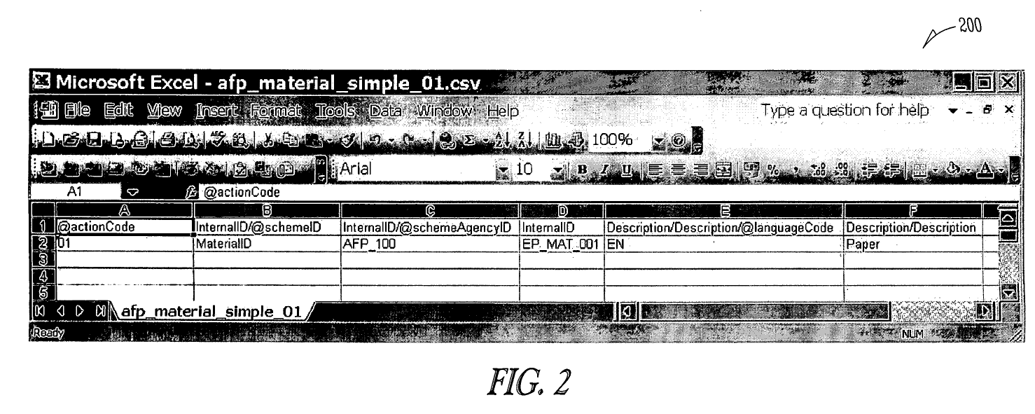

FIG. 2 is a screen shot of an data file 200 in Microsoft Excel format, commonly referred to as comma separated values (CSV). Row 1 contains a header, with column A being an XML attribute, and column B first specifying an XML element and attribute. Column C defines a schema for a resulting XML output and column D an internal id. Column E is a language code and column F a description. The header describes a path in the service so that data can be mapped to the right place in the XML. Row 2 is one row of data corresponding to each of the above columns in the header row. Each further row is a separate service call, corresponding to multiple business object instances. In one embodiment, further columns may easily be added and correspond to multiple occurring segments. In the instant case, further languages may be added. This is simply not feasible in prior hardwired mapping, which is not flexible enough to handle new data without rewriting the hardwired mapping programs.

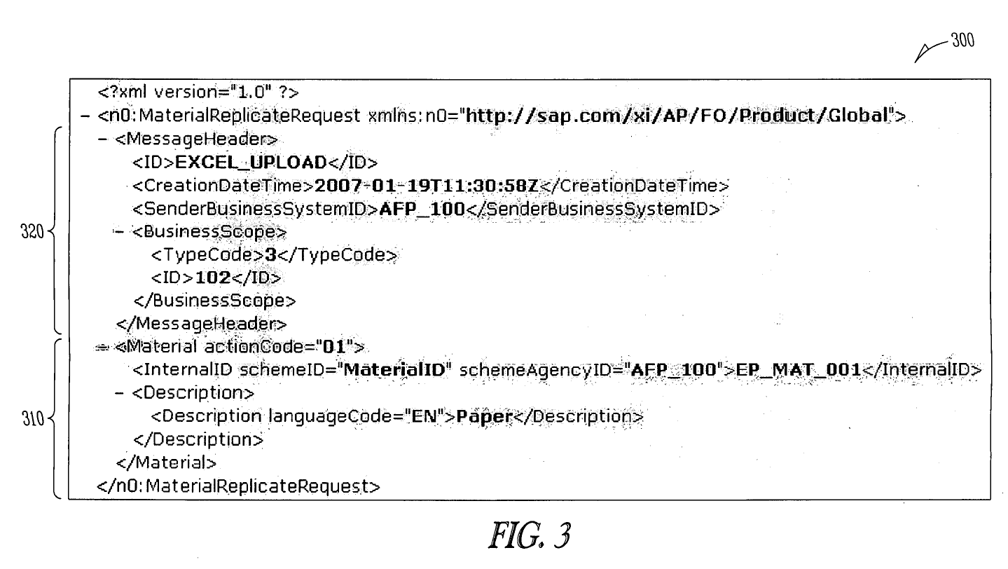

FIG. 3 illustrates the resulting XML body 310 that is automatically extracted from the CSV 200. Tags are derived from the header in row 1 of FIG. 2, with the data from row 2 bolded. A header 320 may also be added during the conversion.

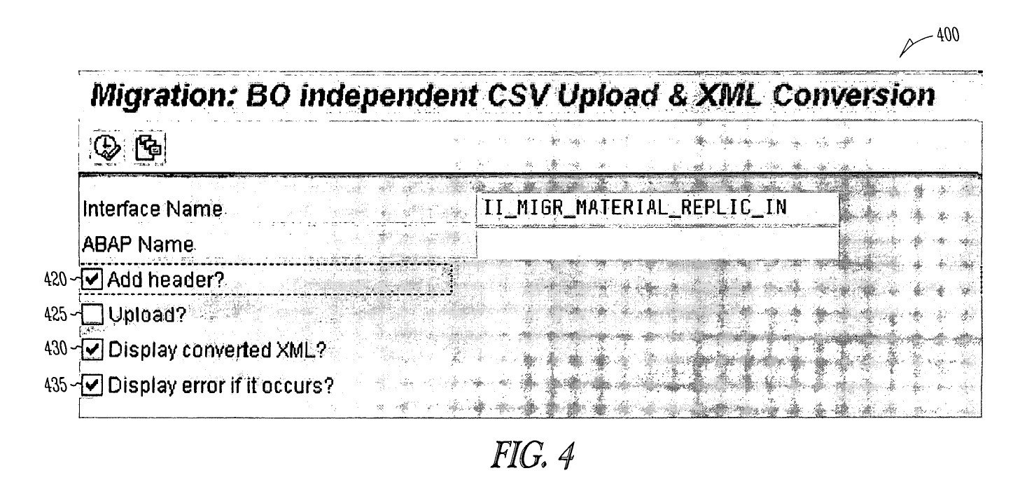

FIG. 4 is a screen shot of an example user interface 400 for file selection and options for converting the file. The interface provides for identification of the file and the service for which XML is to be generated. Check boxes are provided for adding a header at 420, uploading the result at 425, displaying the converted XML at 430 and displaying if an error occurred at 435.

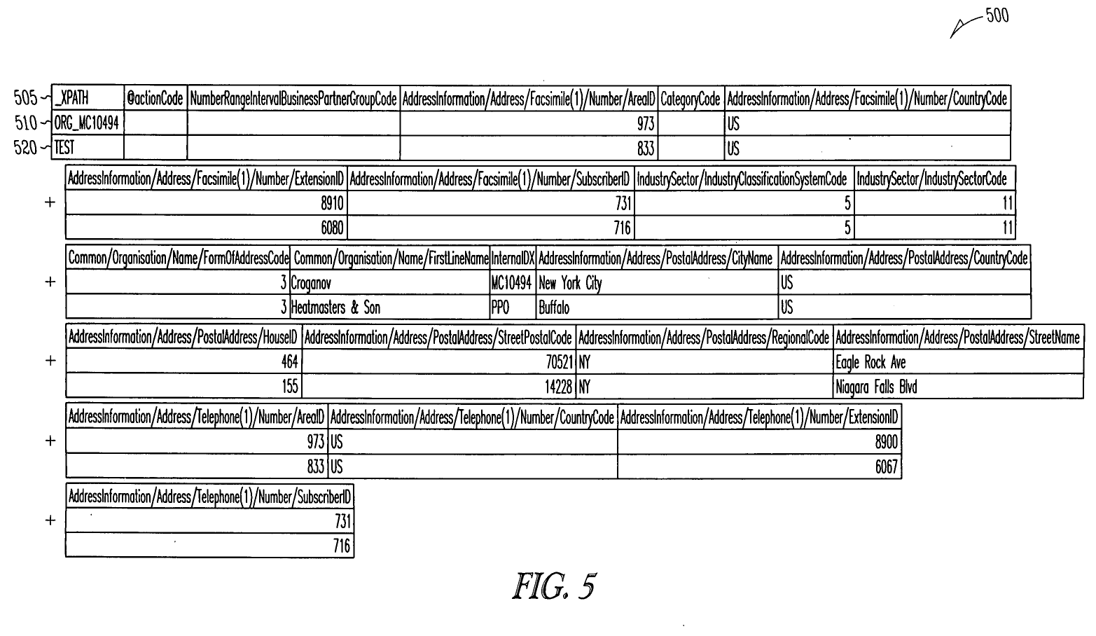

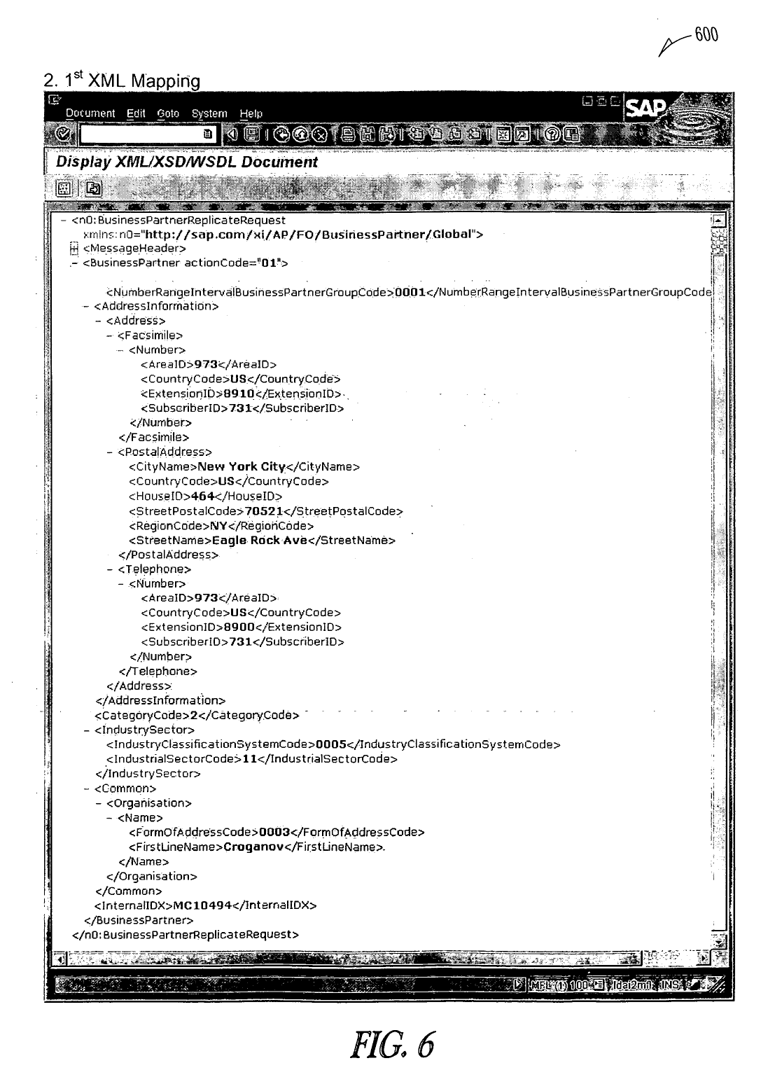

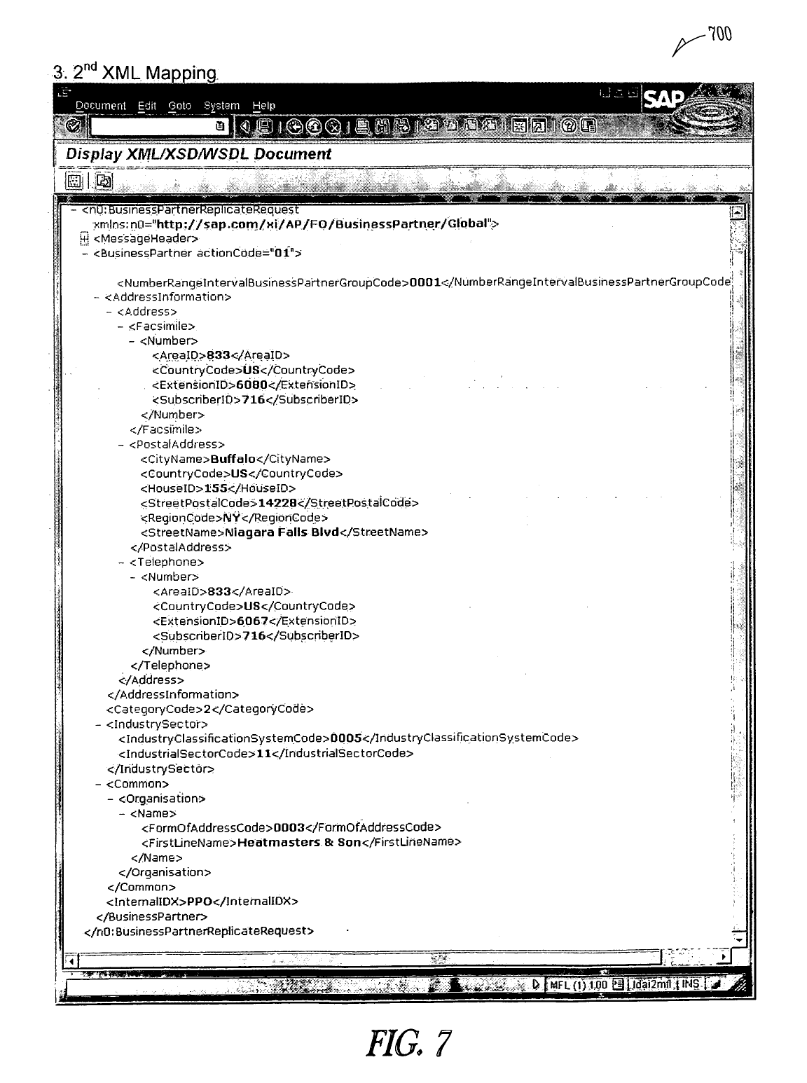

FIG. 5 illustrates a further example of a table 500 that is mapped into two separate XML mappings illustrated at 600 in FIG. 6, corresponding to a first row of data 510, and at 700 in FIG. 7 corresponding to a second row of data 520.

In one embodiment, a conversion routine or method other form of software referred to as TabletoXMLMapping solution uses a header row 505 that corresponds to the schema of the service into which the mapping will be accomplished. A body table that contains the data according to the schema delivered in header table. In this example, there are two rows of data that result in two XML outputs. In further embodiments, more than two lines of data may be provided, each resulting in an XML output. In one embodiment, a method being optional can be determined out of the interface if an inbound method is available.

Then, the TabletoXMLMapping solution generates two XML tables in this embodiment mapped out of input data. An error flag may be generated in case mapping fails. A method name may be provided according to the input interface.

After determining the inbound method name that corresponds to the service's interface name (if it was not provided), a simple transformation from abap to XML is done and the signature is generated. Abap data structure is generated, and then the message namespace information is found out. XML header is therefore generated. Then XML body is concatenated by using the attributes and elements with their corresponding values. Recurring segments are fully supported, for instance more than one address data for a customer. Eventually, XML footer is concatenated into the resulting XML. Accordingly the output XML table is prepared for each line of input body table using the header schema.

A further example of mapping is illustrated by the following example, in which multiple steps are identified corresponding to columns in a table to be mapped. Each step illustrates a column from the table and an addition to an output XML mapping, which is delineated by using a different font and starting just after each use of “XML→”. While separate steps are illustrated, some of the steps may be combined into a single step, or a step may be further divided into additional steps in various embodiments.

Step 1: Add Attribute actionCode with value 01

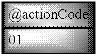

The above two rows are from a first column of the table.
The following is a first line of the body of the mapped XML output:

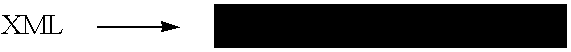

Step 2: Add Node InternalID

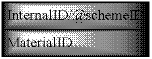

The following illustrates the addition of a line of text to the mapped XML output. Note that new material is highlighted, corresponding to the information dereived from the column and row of data. This means of identifying added script will be used for each succeeding step described below.

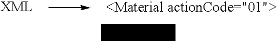

Step 3: Add Attribute schemeID with value MaterialID

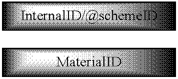

Note that the same column is utilized for two separate steps in the mapping to XML, both for addition of a node internal ID and an attribute scheme ID.

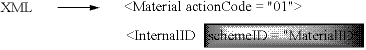

Step 4: Add Attribute schemeAgencyID with value AFL_{—}100

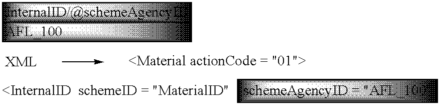

Step 5: Add Node_value ABC_MAT_{—}01

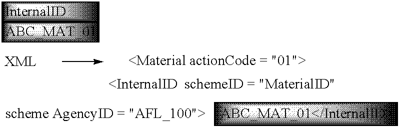

Step 6: Add Node Common

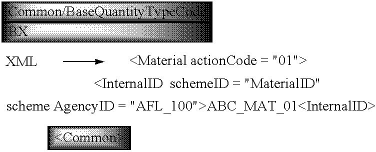

Step 7: Add Node BaseQuantityTypeCode BX

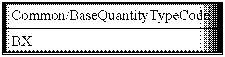

XML → <Material actionCode=“01”>

<InternalID schemeID=“MaterialID”

schemeAgencyID=“AFL_100”>ABC_MAT_01</InternalID>

<Common>

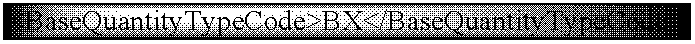

Step 8: Add Node BaseMeasureUnitCode BX

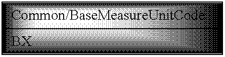

XML → <Material actionCode=“01”>

<InternalID schemeID=“MaterialID”

schemeAgencyID=“AFL_100”>ABC_MAT_01</InternalID>

<Common>

<BaseQuantityTypeCode>BX</BaseQuantityTypeCode>

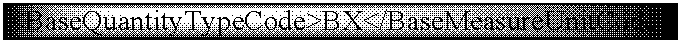

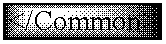

Step 9: Add Node Description(1)

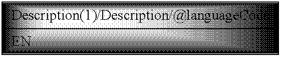

XML → <Material actionCode=“01”

<InternalID schemeID=“MaterialID”

schemeAgencyID=“AFL_100”>ABC_MAT_01</InternalID>

<Common>

<BaseQuantityTypeCode>BX</BaseQuantityTypeCode>
<BaseMeasureUnitCode>BX</BaseMeasureUnitCode>

</Common>

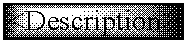

Step 10: Add Node Description

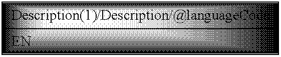

XML → <Material actionCode=“01”>

<InternalID schemeID=“MaterialID”

schemeAgencyID=“AFL_100”>ABC_MAT_01</InternalID>

<Common>

<BaseQuantityTypeCode>BX</BaseQuantityTypeCode>
<BaseMeasureUnitCode>BX</BaseMeasureUnitCode>

</Common>
<Description>

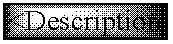

Step 11: Add Attribute languagecode with value EN

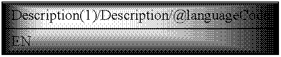

XML → <Material actionCode=“01”>

<InternalID schemeID=“MaterialID”

schemeAgencyID=“AFL_100”>ABC_MAT_01</Internal ID>

<Common>

<BaseQuantityTypeCode>BX</BaseQuantityTypeCode>
<BaseMeasureUnitCode>BX</BaseMeasureUnitCode>

</Common>
<Description>

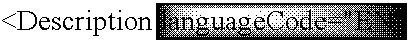

Step 12: Add Node_value english description for ABC_MAT_{—}01

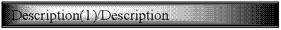

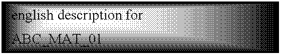

XML → <Material actionCode=“01”>

<InternalID schemeID=“MaterialID”

schemeAgencyID=“AFL_100”>ABC_MAT_01</InternalID>

<Common>

<BaseQuantityTypeCode>BX</BaseQuantityTypeCode>
<BaseMeasureUnitCode>BX</BaseMeasureUnitCode>

</Common>
<Description>

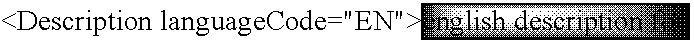

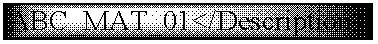

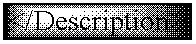

Step 13: Add Node Description(2)

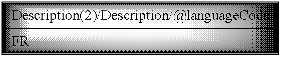

XML → <Material actionCode=“01”>

<InternalID schemeID=“MaterialID”

schemeAgencyID=“AFL_100”>ABC_MAT_01</InternalID>

<Common>

<BaseQuantityTypeCode>BX</BaseQuantityTypeCode>
<BaseMeasureUnitCode>BX</BaseMeasureUnitCode>

</Common>
<Description>

<Description languageCode=“EN”>english description for

ABC_MAT_01</Description>

</Description>

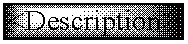

Step 14: Add Node Description

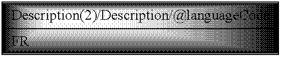

XML → <Material actionCode=“01”>

<InternalID schemeID=“MaterialID”

schemeAgencyID=“AFL_100”>ABC_MAT_01</InternalID>

<Common>

<BaseQuantityTypeCode>BX</BaseQuantityTypeCode>
<BaseMeasureUnitCode>BX</BaseMeasureUnitCode>

</Common>
<Description>

<Description languageCode=“EN”>english description for

ABC_MAT_01</Description>

</Description>
<Description>

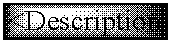

Step 15: Add Attribute languageCode with value FR

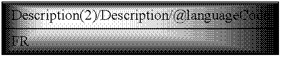

XML → <Material actionCode=“01”>

<InternalID schemeID=“MaterialID”

schemeAgencyID=“AFL_100”>ABC_MAT_01</InternalID>

<Common>

<BaseQuantityTypeCode>BX</BaseQuantityTypeCode>
<BaseMeasureUnitCode>BX</BaseMeasureUnitCode>

</Common>
<Description>

<Description languageCode=“EN”>english description for

ABC_MAT_01</Description>

</Description>
<Description>

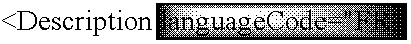

Step 16: Add Node value La description en francais ABC MAT 01

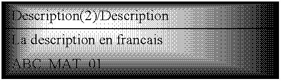

XML → <Material actionCode=“01”>

<InternalID schemeID=“MaterialID”

schemeAgencyID=“AFL_100”>ABC_MAT_01</InternalID>

<Common>

<BaseQuantityTypeCode>BX</BaseQuantityTypeCode>
<BaseMeasureUnitCode>BX</BaseMeasureUnitCode>

</Common>
<Description>

<Description languageCode=“EN”>english description for

ABC_MAT_01</Description>

</Description>
<Description>

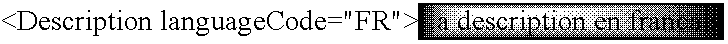

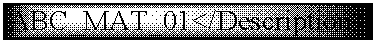

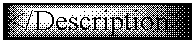

Step 17: Add Node InventoryAndValuationQuantityUnit

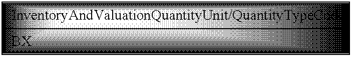

XML → <Material actionCode=“01”>

<InternalID schemeID=“MaterialID”

schemeAgencyID=“AFL_100”>ABC_MAT_01</InternalID>

<Common>

<BaseQuantityTypeCode>BX</BaseQuantityTypeCode>
<BaseMeasureUnitCode>BX</BaseMeasureUnitCode>

</Common>
<Description>

<Description languageCode=“EN”>english description for

ABC_MAT_01</Description>

</Description>
<Description>

<Description languageCode=“FR”>La description en francais

ABC_MAT_01</Description>

</Description>

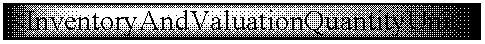

Step 18: Add Node QuantityTypeCode BX

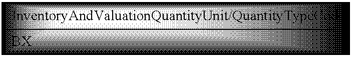

XML → <Material actionCode=“01”>

<InternalID schemeID=“MaterialID”

schemeAgencyID=“AFL_100”>ABC_MAT_01</InternalID>

<Common>

<BaseQuantityTypeCode>BX</BaseQuantityTypeCode>
<BaseMeasureUnitCode>BX</BaseMeasureUnitCode>

</Common>
<Description>

<Description languageCode=“EN”>english description for

ABC_MAT_01</Description>

</Description>
<Description>

<Description languageCode=“FR”>La description en francais

ABC_MAT_01</Description>

</Description>
<InventoryAndValuationQuantityUnit>

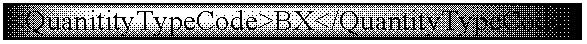

Step 19: Add Node MeasureUnitCode BX

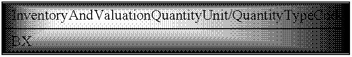

XML → <Material actionCode=“01”>

<InternalID schemeID=“MaterialID”

schemeAgencyID=“AFL_100”>ABC_MAT_01</InternalID>

<Common>

<BaseQuantityTypeCode>BX</BaseQuantityTypeCode>
<BaseMeasureUnitCode>BX</BaseMeasureUnitCode>

</Common>
<Description>

<Description languageCode=“EN”>english description for

ABC_MAT_01</Description>

</Description>
<Description>

<Description languageCode=“FR”>La description en francais

ABC_MAT_01</Description>

</Description>
<InventoryAndValuationQuantityUnit>

<QuantityTypeCode>BX</QuantityTypeCode>

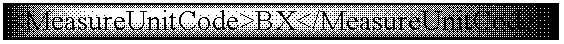

Step 20: Add Node ValuationQuantityUnitIndicator true

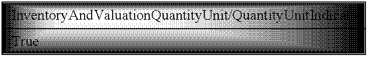

XML → <Material actionCode=“01”>

<InternalID schemeID=“MaterialID”

schemeAgencyID=“AFL_100”>ABC_MAT_01</InternalID>

<Common>

<BaseQuantityTypeCode>BX</BaseQuantityTypeCode>
<BaseMeasureUnitCode>BX</BaseMeasureUnitCode>

</Common>
<Description>

<Description languagecode=“EN”>english description for

ABC_MAT_01</Description>

</Description>
<Description>

<Description languageCode=“FR”>La description en francais

ABC_MAT_01</Description>

</Description>
<InventoryAndValuationQuantityUnit>

<QuantityTypeCode>BX</QuantityTypeCode>
<MeasureUnitCode>BX</MeasureUnitCode>

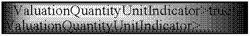

</InventoryAndValuationQuantityUnit>

Step 21: Add message footer

XML → <Material actionCode=“01”>

<InternalID schemeID=“MaterialID”

schemeAgencyID=“AFL 100”>ABC_MAT_01</InternalID>

<Common>

<BaseQuantityTypeCode>BX</BaseQuantityTypeCode>
<BaseMeasureUnitCode>BX</BaseMeasureUnitCode>

</Common>
<Description>

<Description languageCode=“EN”>english description for

ABC_MAT_01</Description>

</Description>
<Description>

<Description languageCode=“FR”>La description en francais

ABC_MAT_01</Description>

</Description>
<InventoryAndValuationQuantityUnit>

<QuantityTypeCode>BX</QuantityTypeCode>
<MeasureUnitCode>BX</MeasureUnitCode>

<ValuationQuantityUnitIndicator>true</
ValuationQuantityUnitIndicator>

>

</InventoryAndValuationQuantityUnit>

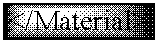

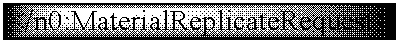

Step 22: Add message header

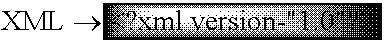

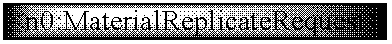

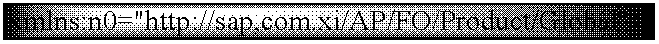

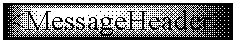

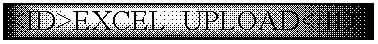

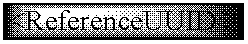

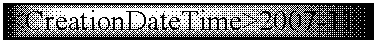

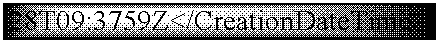

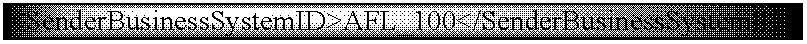

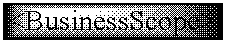

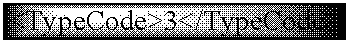

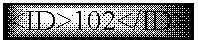

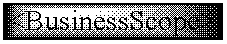

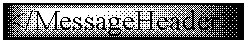

<Material actionCode=“01”>

<InternalID schemeID=“MaterialID”

schemeAgencyID=“AFL_100”>ABC_MAT_01</InternalID>

<Common>

<BaseQuantityTypeCode>BX</BaseQuantityTypeCode>

<BaseMeasureUnitCode>BX</BaseMeasureUnitCode>

</Common>
<Description>

<Description languageCode=“EN”>english description

for ABC_MAT_01</Description>

</Description>
<Description>

<Description languageCode=“FR”>La description en

francais ABC_MAT_01</Description>

</Description>
<InventoryAndValuationQuantityUnit>

<QuantityTypeCode>BX</QuantityTypeCode>
<MeasureUnitCode>BX</MeasureUnitCode>

<ValuationQuantityUnitIndicator>true</
ValuationQuantityUnitIndicator>

</InventoryAndValuationQuantityUnit>
</Material>

</n0:MaterialReplicateRequest>

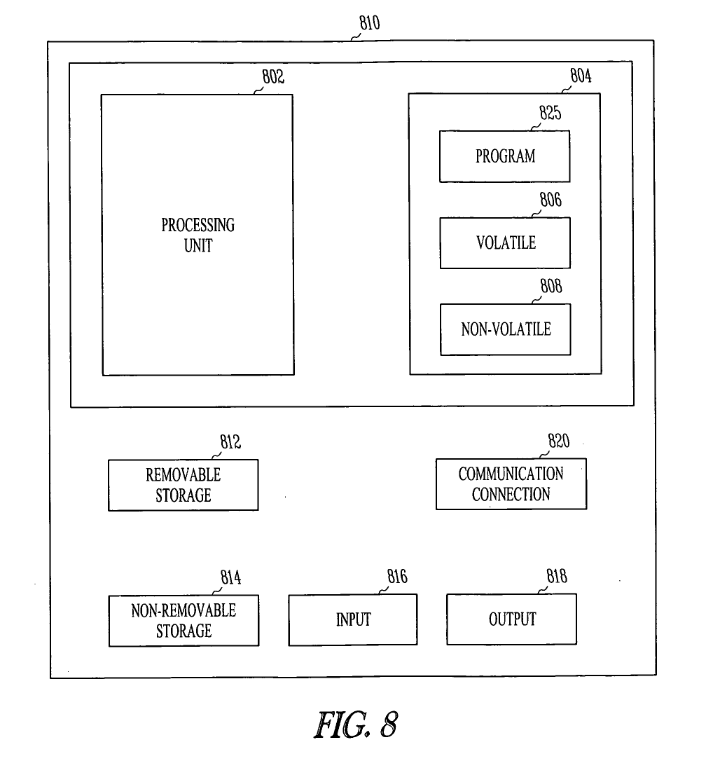

A block diagram of a computer system that executes programming for performing the above methods and mappings is shown in FIG. 8. A general computing device in the form of a computer 810, may include a processing unit 802, memory 804, removable storage 812, and non-removable storage 814. Memory 804 may include volatile memory 806 and non-volatile memory 808. Computer 810 may include—or have access to a computing environment that includes—a variety of computer-readable media, such as volatile memory 806 and non-volatile memory 808, removable storage 812 and non-removable storage 814. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 810 may include or have access to a computing environment that includes input 816, output 818, and a communication connection 820. The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 802 of the computer 810. A hard drive, CD-ROM, and RAM are some examples of articles including a computer-readable medium.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. A method comprising:
receiving a table of data from a source service in a format specific to the source service;
reading a table header from the received table of data that includes a data schema specific to a destination service in the received table;
using a converter to map data in the table to one or more tag based mark up language tables compatible with the table header data schema of the destination service, wherein the data schema may be varied to identify different data schemas for different destination services without modifying the converter.

2. The method of claim 1 wherein the tab based mark up language comprises (extensible markup language) XML.

3. The method of claim 2 wherein the destination services comprise business objects having different data schema.

4. The method of claim 1 wherein the table of data comprises comma separated values.

5. The method of claim 1 wherein the table of data format corresponds to a relational database.

6. The method of claim 1 wherein the table of data from the source service corresponds to legacy application data and the destination service corresponds to a new application to which a user is upgrading.

7. The method of claim 1 wherein the table header data and table data encapsulate data that corresponds to a destination service structure and service interface name.

8. The method of claim 1 wherein the table header comprises a first row of information in the table, and each succeeding row is mapped to a separate tag based mark up language table corresponding to different instances of a business object in the destination service.

9. A computer readable medium having instructions for cause a computer to execute a method, the method comprising:
receiving a table of data from a source service in a format specific to the source service;
reading a table header from the received table of data that includes a data schema specific to a destination service in the received table;
using a converter to map data in the table to one or more tag based mark up language tables compatible with the table header data schema of the destination service, wherein the data schema may be varied to identify different data schemas for different destination services without modifying the converter.

10. The computer readable medium of claim 9 wherein the tab based mark up language comprises (extensible markup language) XML.

11. The computer readable medium of claim 10 wherein the destination services comprise business objects having different data schema.

12. The computer readable medium of claim 9 wherein the table of data comprises comma separated values.

13. The computer readable medium of claim 9 wherein the table of data format corresponds to a relational database.

14. The computer readable medium of claim 9 wherein the table of data from the source service corresponds to legacy application data and the destination service corresponds to a new application to which a user is upgrading.

15. The computer readable medium of claim 9 wherein the table header data and table data encapsulate data that corresponds to a destination service structure and service interface name.

16. The computer readable medium of claim 9 wherein the table header comprises a first row of information in the table, and each succeeding row is mapped to a separate tag based mark up language table corresponding to different instances of a business object in the destination service.

17. A system comprising:
a receiving module that receives a table of data from a source service in a format specific to the source service;
a reading module that reads a table header from the received table of data that includes a data schema specific to a destination service in the received table;
a converter to map data in the table to one or more tag based mark up language tables compatible with the table header data schema of the destination service, wherein the data schema may be varied to identify different data schemas for different destination services without modifying the converter.

18. The system of claim 17 wherein the tab based mark up language comprises (extensible markup language) XML.

19. The system of claim 18 wherein the destination services comprise business objects having different data schema and wherein the table of data comprises comma separated values.

20. The system of claim 17 wherein the table header data and table data encapsulate data that corresponds to a destination service structure and service interface name and wherein the table header comprises a first row of information in the table, and each succeeding row is mapped to a separate tag based mark up language table corresponding to different instances of a business object in the destination service.
